(19) United States
(12) Patent Application Publication
(10) Pub. No.: US 2026/0163468 A1
(43) Pub. Date: Jun. 11, 2026

(54) SYSTEM FOR PROVIDING A SOFT STOP DC/DC CONVERTER

(71) Applicant: Lear Corporation, Southfield, MI (US)

(72) Inventors: ADRIA MARCOS PASTOR, Valls (ES); ANDRE CARTAXO, Valls (ES); SERGIO MARTINEZ PORRAS, Valls (ES); MARC RAMIREZ CARMONA, Valls (ES); ANTONIO MARTINEZ PEREZ, Valls (ES)

(21) Appl. No.: 18/970,009

(22) Filed: Dec. 5, 2024

(51) Int. Cl. H02M 1/32; H02M 1/36; H02M 3/00; H02M 3/335

(52) U.S. Cl. CPC H02M 1/32; H02M 1/36; H02M 3/01; H02M 3/33573

(57) ABSTRACT

In at least one embodiment, a system comprising a first circuit, a passive circuit, and at least one controller is provided. The first circuit comprises a plurality of switches, each of the plurality of switches selectively activated, wherein, in accordance with selective activation of a switch of the plurality of switches, a first voltage signal is generated in response to one or more second voltage signals. The passive circuit comprises one or more passive components. The passive circuit generating a third voltage signal based on the first voltage signal. The at least one controller programmed to receive an input indicative of the system in an overload condition and, responsive to the input, select a first set of switches of the plurality of switches. With the selection of the first set of switches, enabling the one or more passive components of the passive circuit to discharge the third voltage signal.

### TECHNICAL FIELD

Aspects disclosed herein generally relate to a system for providing a soft stop direct current (DC)/DC converter. These aspects and others will be discussed in more detail herein.

### BRIEF DESCRIPTION OF THE DRAWINGS

FIG. 1 depicts one example of a system for providing a soft stop DC to DC converter in accordance with one embodiment;

FIG. 2 depicts a detailed implementation of the DC/DC converter in accordance with one embodiment;

FIG. 3 depicts the DC/DC converter of FIG. 2 in which one or more switches are closed during an overload condition in accordance with one embodiment; and

FIG. 4 depicts various waveforms associated with the DC/DC converter during the overload condition in accordance with one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In a resonant circuit (e.g., LLC-type)-direct current (DC)/ DC converter for an on-board charger (OBC) in a vehicle, when an overload current (or overload condition) is detected, a charging system enables, for example, a pair of controlled switches in the DC/DC converter to close (or remain ON) until energy in a resonant tank is minimized. The pair of controlled switches in the DC/DC converter may be disabled (or switched OFF) after an elapsed period of time during the overload condition once current within the resonant tank reduces to a negligible value.

For example, a controller that is operably coupled to the DC/DC converter may, after detecting an overcurrent (or overload condition) may continue to activate, for example, at least two switches positioned within the DC/DC converter to maintain or preserve a connection between the DC/DC converter, a DC-Link, and a resonant tank. In this case, by activating the two switches during the overload condition, energy within the resonant tank dissipates to a low level. Upon the energy dissipating to the low or negligible level in the resonant tank, the controller may disable the switches to ensure a soft-stop operation with respect to the switches. If all of the switches were disabled by the controller during the overload condition, energy within the resonant tank is discharged thereby forcing undesired over voltages to the switches which may result in damaging such switches. The disclosed system is robust in moments of over-current conditions caused by a fault load (e.g., a battery or high-voltage (HV) condition) and prevents aspects related to the charging system from being damaged.

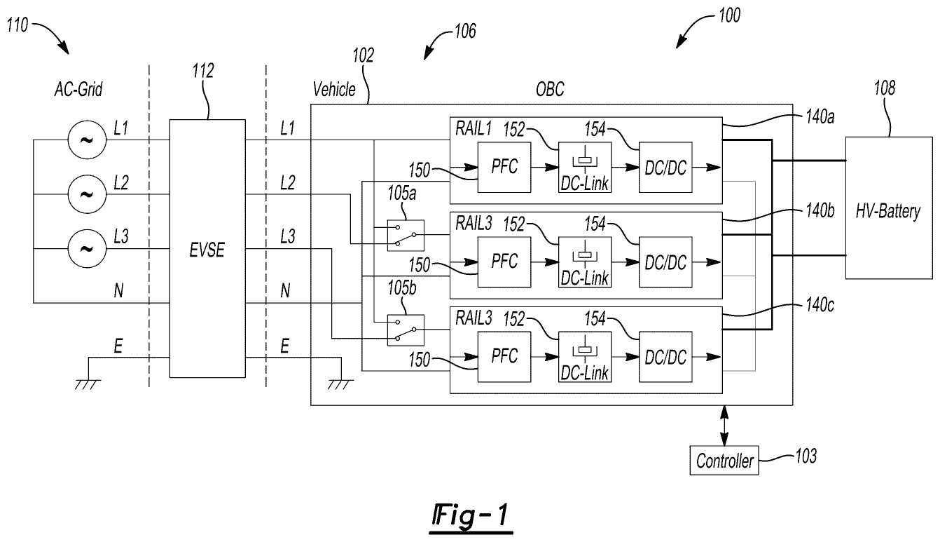

FIG. 1 depicts one example of a system 100 (e.g. charging system 100) in accordance with one embodiment. The system 100 includes an onboard charger (OBC) 102 and one or more batteries 108 (e.g., battery 108) positioned in a vehicle 104. The onboard charger 102 may be operably coupled to an alternating current (AC) grid 110 for receiving AC energy to charge the one or more batteries 108. The OBC 102 is generally configured to rectify the AC energy into a direct current (DC) energy for storage on battery 108. In another example, the OBC may invert DC energy as provided by the battery 108 into AC energy to transfer AC energy back on to the AC grid 110.

The OBC 102 may be operably coupled to the AC grid 110 via a charging station 112 (or electric vehicle supply equipment (EVSE)). The charging station 112 transfers energy between the AC grid 110 and the vehicle 104. The charging station 112 may be operably coupled to various outputs such as lines (L1, L2, L3, and Neutral (N)) of the AC grid 110 to facilitate such energy transfer. The OBC 102 includes a plurality of modular converters 140a-140c (or “140”). It is recognized that the number of modular converters 140a-140c positioned within the OBC 102 may vary based on the desired criteria of a particular implementation. The system 100 further includes at least one controller 103 (“the controller 103”) and a plurality of switching blocks 105a-105b. Similarly, the number of switching blocks 105a-105b utilized within the OBC 102 may vary based on the desired criteria of a particular implementation.

In general, the controller 103 may selectively activate or deactivate one or more of the switching blocks 105a-105b to control the various modular converter 140a-140c to facilitate transferring energy from the AC grid 110 to the battery 108. Similarly, the controller 103 may selectively activate or deactivate one or more of the switching blocks 105a-105b to control the various modular converters 140a-140c to facilitate transferring energy from the battery 108 to the AC grid 110. Each of the modular converters 140 includes a power factor corrector (PFC) 150, a DC link capacitor 152, and a DC/DC converter 154. The controller 103 also controls the PFC 150 to perform AC/DC conversion to ensure a high-power factor at an input of the DC/DC converter 154. The PFC 150 and the DC/DC converter 154 are electrically coupled to one another via a capacitive energy buffer (or the DC link capacitor 152). The controller 103 controls the DC/DC converter 154 to convert a high-voltage stabilized input provided by the DC link capacitor 152 into a DC voltage level that is suitable for storage on the battery 108. In general, the DC/DC converter 154 converts a high voltage input (e.g., high voltage DC input) as provided by the PFC 150 into a low voltage output for storage on the battery 108.

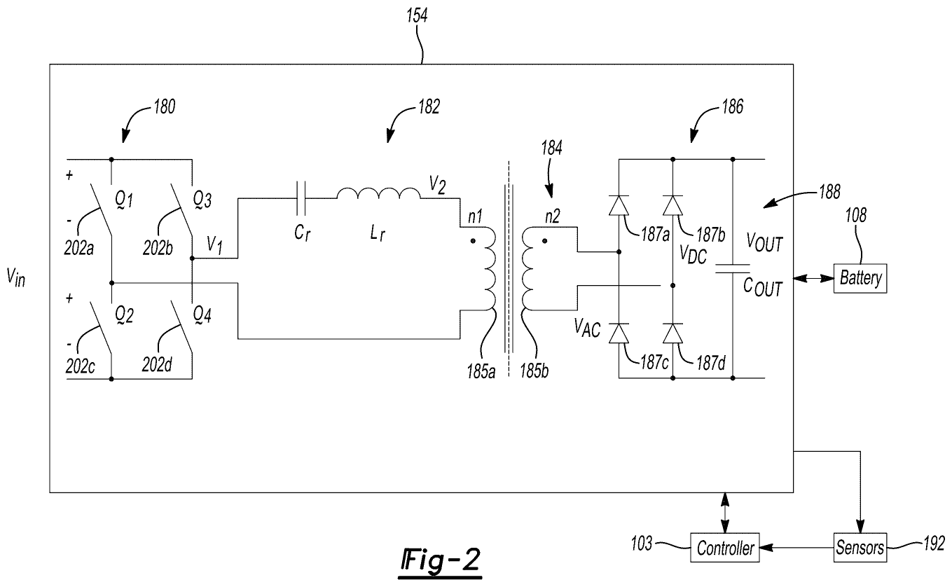

FIG. 2 depicts a detailed implementation of the DC/DC converter 154 in accordance with one embodiment. Each of the DC/DC converters 154 includes a first circuit 180, a passive circuit 182, a transformer 184, an output rectifier 186, and an output filter 188. The controller 103 selectively controls one or more switches 202a-202d of the first circuit 180 to generate a first voltage signal V1 in response to an input voltage signal (e.g. Vin +/−). For example, the controller 103 selectively activates and deactivates the one or more switches 202a-202D at a corresponding switching frequency to generate the first voltage signal V1 based on the input voltage signal.

The passive circuit 182 may be implemented as a resonant tank and includes one or more passive components such as one or more capacitors Cr (“the capacitor Cr”) and one or more inductors Lr (“the inductor Lr”). The passive circuit 182 provides a selective gain response to the transformer 184 based on the switching frequency utilized by the controller 103 to selectively activate and deactivate the one or more switches 202a-202d. For example, the switches 202a-202d provide an AC based voltage (or the first voltage signal V1) with a varying frequency to the passive circuit 182. The passive circuit 182 either attenuates or amplifies the AC based voltage based on the frequency of the AC based voltage to generate an AC based voltage output Vac. This aspect enables the DC/DC converter 154 with the capability to step up or step down a voltage (e.g., V2) as provided by the passive circuit 182.

The transformer 184 generally includes a primary side 185a and a secondary side 185b. The transformer 184 includes a predetermined number of windings (or turns) on each of the primary side 185a and the secondary side 185b. In one example, the transformer 184 may be close to a 1:1 component. For example, the transformer 184 may include or have a 14:15 turns ratio for an 11 kW production OBC unit. The transformer 184 generally serves to isolate the AC based voltage (or waveform) provided by the passive circuit 182. The output rectifier 186 generally includes a plurality of diodes 187a-187d that function as a rectifier to provide a DC based low voltage Vdc in response to the voltage Vac provided by the transformer 184. The output filter 188 includes a capacitor Cout to filter the DC based low voltage Vdc to provide a final output voltage Vout. The final output voltage Vout is suitable for storage on the battery 108.

The system 100 includes one or more current (or voltage) sensors 192 (e.g., the sensor 192) may be positioned about the DC/DC converter 154. The sensor 192 provides an output indicative of current or voltage of the DC based low voltage Vdc as provided by the DC/DC converter 154 to the controller 103. The controller 103 compares the measured voltage or current to a predetermined value to determine if the DC/DC converter 154 (or system 100) is in an overload condition. With the overload condition, the DC/DC converter 154 may be generating excess current or voltage and it is desirable at this point to deactivate the DC/DC converter 154 to avoid damaging various components. If the measured voltage or current exceeds the predetermined value, the controller 103 determines that the system 100 is in an overload condition.

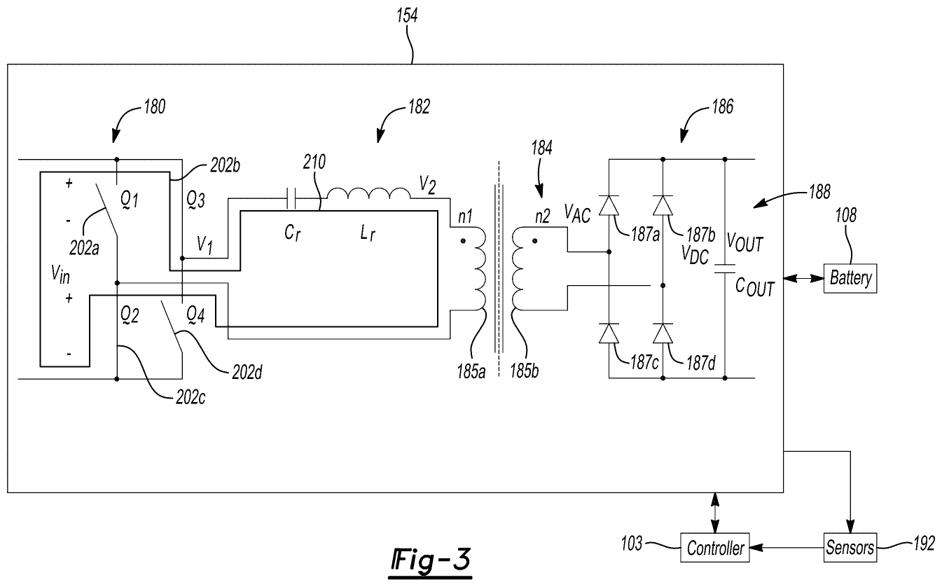

When the overload condition is detected, the controller 103 continues to selectively activate, for example, at least two of the switches 202a-202d while the passive circuit (or resonant tank) 182 discharges voltage across its capacitor and inductance prior to completely deactivating all of the switches 202a-202d. FIG. 3 generally illustrates the condition whereby the prior implementations utilize a controller that completely deactivates the switches 202a-202d when the overload condition is detected which may force undesired overvoltage to the transfer to the switches 202a-202d thereby possibly damaging such switches. By continuing to allow at least two switches 202a-202d to be activated during the overload condition via a soft-stop operation, the passive circuit 182 is allowed to completely discharge the current and prevent undesired voltage from reaching the switches 202a-202d. For example, the energy that is stored in the capacitor Cr and the inductor Ir in the passive circuit 182 should be discharged to avoid damaging the switches 202a-202d.

FIG. 3 depicts the condition in which the energy in the passive circuit 182 is discharged via a loop 210. Given that the DC link capacitor 152 is positioned in series with the DC/DC converter 154 (e.g., in series with the capacitor Cr of the DC/DC converter 154), energy from the DC link capacitor 152 will not flow into the DC/DC converter 154. Upon the controller 103 determining that a current across the passive circuit 182 is reduced to negligible values based on measurements provided by the sensors 192, the controller 103 may then deactivate the remaining switches 202a-202d such that the DC/DC converter 154 ceases to provide the DC based voltage Vdc. For example, as shown in FIG. 3, in response to the controller 103 determining that the DC/DC converter 154 is in the overload condition, the controller 103 may selectively activate two of the switches 202b and 202c to discharge energy from the passive circuit 182. The controller 103 may employ the soft stop operation during the overload condition by activating at least two of the switches 202a-202d for, for example, two switching cycles (or e.g., 16 μs) to enable the capacitor Cr and/or inductor Ir adequate time to fully discharge. The soft-stop operation may be more advantegous in this case over a hard stop operation (e.g., all switches 202a-202d are closed) to prevent or minimize the likelihood of the switches 202a-202d being damaged by excessive energy being discharged by the passive circuit 182.

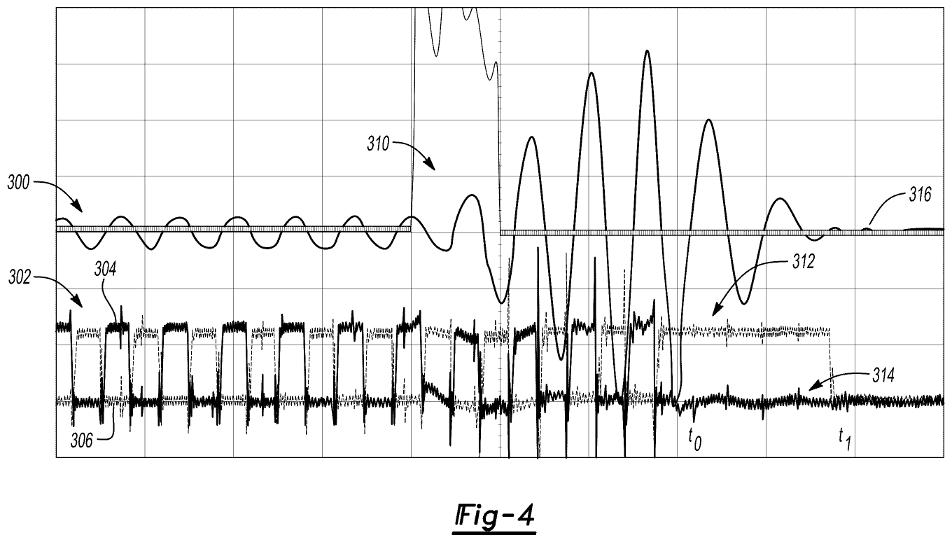

FIG. 4 depicts various waveforms associated with the DC/DC converter 154 during the overload condition in accordance with one embodiment. Waveform 300 generally corresponds to an amount of energy (or current) flowing in the passive circuit 182. Waveform 302 generally corresponds to the switching current being applied to the switches 202a-202d to activate/deactivate the same. In particular, waveform 304 generally corresponds to a switching current being applied to the switches 202b, 202c. Waveform 306 generally corresponds to a switching current being applied to the switches 202a, 202d. At 310, this condition generally indicates the moment in which the DC/DC converter 154 starts to experience an overload condition. At 312, this condition generally corresponds to the moment in which the controller 103 deactivates the switches 202b, 202c in response to the overload condition being detected. As shown at 314, the controller 103 continues to selectively activate the switches 202a, 202d while deactivating the switches 202b, 202c during the overload condition. At 316, it can be seen that the passive circuit 182 fully discharges.

Item 1. A system comprising a first circuit, a passive circuit, and at least one controller. The first circuit comprises a plurality of switches, each of the plurality of switches selectively activated, wherein, in accordance with selective activation of a switch of the plurality of switches, a first voltage signal is generated in response to one or more second voltage signals. The passive circuit comprises one or more passive components. The passive circuit generating a third voltage signal based on the first voltage signal. The at least one controller programmed to receive an input indicative of the system in an overload condition and, responsive to the input, select a first set of switches of the plurality of switches. With the selection of the first set of switches, enabling the one or more passive components of the passive circuit to discharge the third voltage signal.

Item 2. According to item 1, the plurality of switches receiving the one or more first voltage signals at a switching frequency.

Item 3. According to item 1, the passive circuit generating the third voltage signal by attenuating the first voltage signal based on a switching frequency employed by the at least one controller to activate the switch of the plurality of switches.

Item 4. According to item 1, the passive circuit generating the third voltage signal by increasing the first voltage signal that is based on a switching frequency employed by the at least one controller to activate the switch of the plurality of switches.

Item 5. According to item 1 comprising a transformer operably coupled to the passive circuit providing an alternating current (AC) waveform based on the third voltage signal.

Item 6. According to item 5 comprising an output rectifier generating a direct current (DC) voltage signal by rectifying the AC waveform.

Item 7. According to item 6 comprising an output filter providing a filtered DC voltage signal based on the DC voltage signal.

Item 8. According to item 7, the at least one controller is further programmed to compare a DC input value provided on the input to a predetermined value and to selectively activate the first set of the plurality of switches based on the comparison.

Item 9. According to item 8, the at least one controller is further programmed to selectively activate the first set of the plurality of switches responsive to the DC input value being greater than the predetermined value.

Item 10. According to item 1, the one or more passive components of the passive circuit comprises a capacitor and an inductor.

Item 11. According to item 1, the at least one controller is further programmed to, when the system is in the overload condition, selectively deactivate a second set of the plurality of switches.

Item 12. According to item 11, when the at one least controller selectively deactivates the second set of the plurality of switches, the at least one controller activates the first set of the plurality of switches to discharge the third voltage signal from the one or more passive components.

Item 13. A system comprising a first circuit, a passive circuit, and at least one controller. The first circuit comprises a plurality of switches, each of the plurality of switches selectively activated, wherein, in accordance with selective activation of a switch of the plurality of switches, a first voltage signal is generated in response to one or more second voltage signals. The passive circuit generating a third voltage signal based on the first voltage signal. The at least one controller programmed to receive an input indicative of the system in an overload condition and, responsive to the input, select a first set of switches of the plurality of switches. With the selection of the first set of switches, enabling the passive circuit to discharge the third voltage signal.

Item 14. According to item 13, the passive circuit generates the third voltage signal by attenuating the first voltage signal based on a first switching frequency employed by the at least one controller to activate the switch of the plurality of switches.

Item 15. According to item 14, the passive circuit generates the third voltage signal by increasing the first voltage signal that is based on a second switching frequency employed by the at least one controller to activate the switch of the plurality of switches.

Item 16. According to item 15, the first switching frequency is different than the second switching frequency.

Item 17. According to item 13, the passive circuit includes a capacitor and an inductor, and wherein the capacitor and the inductor are positioned in series with one another.

Item 18. According to item 13, when the system is in the overload condition, the at least one controller selectively deactivates a second set of the plurality of switches while activating the first set of switches of the plurality of switches to discharge the second third voltage signal from the passive circuit.

Item 19. According to item 13, the first set of switches of the plurality of switches corresponds to at least two switches of the plurality of switches.

Item 20. A system comprising a first circuit, a passive circuit, and at least one controller. The first circuit comprises a plurality of switches, each of the plurality of switches selectively activated, wherein, in accordance with selective activation of a switch of the plurality of switches, a first voltage signal is generated in response to one or more second voltage signals. The passive circuit generating a third voltage signal based on the first voltage signal. The at least one controller programmed to receive an input indicative of the system in an overload condition and, responsive to the input, select a first set of switches of the plurality of switches. With the selection of the first set of switches, enabling the passive circuit to discharge the third voltage signal.

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilizes one or more microprocessors to execute a computer-program that is embodied in a non-transitory computer readable medium that is programmed to perform any number of the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware-based inputs and outputs for receiving and transmitting data, respectively from and to other hardware-based devices as discussed herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a first circuit comprising a plurality of switches, each of the plurality of switches selectively activated, wherein, in accordance with selective activation of a switch of the plurality of switches, a first voltage signal is generated in response to one or more second voltage signals;
a passive circuit comprising one or more passive components, the passive circuit generating a third voltage signal based on the first voltage signal; and
at least one controller programmed to receive an input indicative of the system in an overload condition and, responsive to the input, select a first set of switches of the plurality of switches, wherein in accordance with the selection of the first set of switches, enabling the one or more passive components of the passive circuit to discharge the third voltage signal.

2. The system of claim 1, wherein the plurality of switches receiving the one or more second voltage signals at a switching frequency.

3. The system of claim 1, wherein the passive circuit generates the third voltage signal by attenuating the first voltage signal based on a switching frequency employed by the at least one controller to activate the switch of the plurality of switches.

4. The system of claim 1, wherein the passive circuit generates the third voltage signal by increasing the first voltage signal that is based on a switching frequency employed by the at least one controller to activate the switch of the plurality of switches.

5. The system of claim 1 further comprising a transformer operably coupled to the passive circuit providing an alternating current (AC) waveform based on the third voltage signal.

6. The system of claim 5 further comprising an output rectifier generating a direct current (DC) voltage signal by rectifying the AC waveform.

7. The system of claim 6 further comprising an output filter providing a filtered DC voltage signal based on the DC voltage signal.

8. The system of claim 7, wherein the at least one controller is further programmed to compare a DC input value provided on the input to a predetermined value and to selectively activate the first set of the plurality of switches based on the comparison.

9. The system of claim 8, wherein the at least one controller is further programmed to selectively activate the first set of the plurality of switches responsive to the DC input value being greater than the predetermined value.

10. The system of claim 1, wherein the one or more passive components of the passive circuit comprises a capacitor and an inductor.

11. The system of claim 1, wherein the at least one controller is further programmed to, when the system is in the overload condition, selectively deactivate a second set of the plurality of switches.

12. The system of claim 11, wherein, when the at least one controller selectively deactivates the second set of the plurality of switches, the at least one controller activates the first set of the plurality of switches to discharge the third voltage signal from the one or more passive components.

13. A system comprising:
a first circuit comprising a plurality of switches, each of the plurality of switches selectively activated, wherein, in accordance with selective activation of a switch of the plurality of switches, a first voltage signal is generated in response to one or more second voltage signals;
a passive circuit generating a third voltage signal based on the first voltage signal; and
at least one controller programmed to receive an input indicative of the system in an overload condition and, responsive to the input, select a first set of switches of the plurality of switches wherein in accordance with the selection of the first set of switches, enabling the passive circuit to discharge the third voltage signal.

14. The system of claim 13, wherein the passive circuit generates the third voltage signal by attenuating the first voltage signal based on a first switching frequency employed by the at least one controller to activate the switch of the plurality of switches.

15. The system of claim 14, wherein the passive circuit generates the third voltage signal by increasing the first voltage signal that is based on a second switching frequency employed by the at least one controller to activate the switch of the plurality of switches.

16. The system of claim 15, wherein the first switching frequency is different than the second switching frequency.

17. The system of claim 13, wherein the passive circuit includes a capacitor and an inductor, and wherein the capacitor and the inductor are positioned in series with one another.

18. The system of claim 13, wherein, when the system is in the overload condition, the at least one controller selectively deactivates a second set of the plurality of switches while activating the first set of switches of the plurality of switches to discharge the third voltage signal from the passive circuit.

19. The system of claim 13, wherein the first set of switches of the plurality of switches corresponds to at least two switches of the plurality of switches.

20. A system comprising:
a plurality of switches, each of the plurality of switches selectively activated, wherein, in accordance with selective activation of a switch of the plurality of switches, a first voltage signal is generated in response to one or more second voltage signals;
a passive circuit generating a third voltage signal based on the first voltage signal; and
at least one controller programmed to receive an input indicative of the system being in an overload condition and, responsive to the input, selectively activate a first set of the plurality of switches and selectively deactivate a second set of plurality of switches, wherein in accordance with the selective activation of the first set of the plurality of switches and the selective deactivation of the second set of the plurality of switches, enabling the passive circuit to discharge the third voltage signal.
